(19) United States
(12) Patent Application Publication
(10) Pub. No.: US 2026/0197333 A1
(43) Pub. Date: Jul. 9, 2026

(54) Cloud observability framework for providing troubleshooting and monitoring for services

(71) Applicant: Zscaler, Inc., San Jose, CA (US)

(72) Inventors: Ravinder Varkali, San Jose, CA (US); Sunil Chappidi, San Jose, CA (US); Bhushan Chitte, San Jose, CA (US); Sushil Pangeni, Fremont, CA (US); Jaspreet Singh, Sunnyvale, CA (US); Manpreet Chadha, London (GB); Ruchita Dinesh Entoliya, San Jose, CA (US); Ramesh Kumar Somasundaram, San Jose, CA (US); Kriti Chapagain, San Jose, CA (US); Di Wang, Burnaby (CA); Noorul Hussain, Bangalore (IN); Rahul Dhere, Bangalore (IN); Abhishek R S, Bangalore (IN); Pramit Gupta, Bangalore (IN); Aniket Singh, Mohali (IN); Adi Sathya Sai, Bangalore (IN); Karthik Sampathu, Bangalore (IN); Prithvi Manoj Krishna, Nova Scotia (CA); Renushree G, Bangalore (IN); Nishank Pandey, Bangalore (IN); Haripriya R, Bangalore (IN); Clark Chan, San Jose, CA (US); Pranjal Jain, Bangalore (IN); Varghese Kallarackal, San Jose, CA (US); Kumar Sanghvi, San Jose, CA (US)

(73) Assignee: Zscaler, Inc., San Jose, CA (US)

(21) Appl. No.: 19/069,767

(22) Filed: Mar. 4, 2025

(30) Foreign Application Priority Data
Jan. 6, 2025 (IN) 202541001061

(51) Int. Cl. H04L 9/40

(52) U.S. Cl. CPC H04L 63/1425

(57) ABSTRACT

Systems and methods for providing monitoring and troubleshooting for services of a cloud-based system include receiving a request from a user, the request being for any of monitoring and troubleshooting one or more services provided by the cloud-based system; submitting a job to one or more observability agents associated with the one or more services of the cloud-based system; receiving a response from the one or more observability agents, the response including metrics associated with the one or more services; and providing the response to the user.

### FIELD OF THE DISCLOSURE

The present disclosure generally relates to network and cloud security. More particularly, the present disclosure relates to systems and methods for a cloud observability framework for providing troubleshooting and monitoring for services of a cloud-based system.

### BACKGROUND OF THE DISCLOSURE

Collecting metrics from different cloud services can be challenging due to the varied architectures and interfaces each service uses. Different cloud providers, like AWS, Azure, and Google Cloud, have their own monitoring tools, APIs, and formats for logging and metrics, which makes it difficult to standardize data collection across platforms. Integrating data from these diverse sources often requires custom solutions or third-party tools, adding complexity and potential compatibility issues. Additionally, services can be distributed across multiple regions or instances, making it harder to aggregate data in a cohesive way. The varying formats and methods of accessing this information can result in incomplete data or delays in analysis, making it more difficult for IT teams to get a comprehensive view of system performance and quickly identify issues.

### BRIEF SUMMARY OF THE DISCLOSURE

The present disclosure relates to systems and methods for a cloud observability framework for providing troubleshooting and monitoring for services of a cloud-based system. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving a request from a user, the request being for any of monitoring and troubleshooting one or more services provided by the cloud-based system; submitting a job to one or more observability agents associated with the one or more services of the cloud-based system; receiving a response from the one or more observability agents, the response including metrics associated with the one or more services; and providing the response to the user.

The steps can further include providing a real-time status of the request to the user between receiving the request and providing the response. Providing the response to the user can be via a User Interface (UI), wherein the response includes graphical representations of the metrics associated with the one or more services. The one or more observability agents can be service-specific and tailored to specific requirements of their associated service. Each of the one or more service-specific observability agents can follow a unified protocol for interacting with the cloud observability framework. The steps can include performing a registration procedure for each of the one or more observability agents, thereby ensuring that the cloud observability framework is aware of all available observability agents and their functionalities. The cloud observability framework can be adapted to submit jobs to specific observability agents based on the one or more services associated with the request.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of the present observability framework.

FIG. 6 is a flow diagram of an example request flow through the observability framework.

FIG. 7 is a flowchart of a process for a cloud observability framework.

### DETAILED DESCRIPTION OF THE DISCLOSURE

Again, the present disclosure relates to systems and methods for a cloud observability framework for providing troubleshooting and monitoring for services of a cloud-based system. Various embodiments integrate various tools and techniques to monitor, analyze, and optimize the health and performance of the network, applications, and infrastructure of the cloud-based system described herein. Core components include a front end for user interaction and authentication, a central controller for managing and executing requests, and service-specific agents that collect metrics and execute commands. The framework leverages APIs for seamless communication, supports flexible and dynamic troubleshooting through a JavaScript interpreter, and integrates with external services like Prometheus and Kafka for data storage and streaming. This robust and scalable framework ensures reliable and efficient monitoring and troubleshooting capabilities across all service instances.

### § 1.0 Cybersecurity Monitoring and Protection Examples

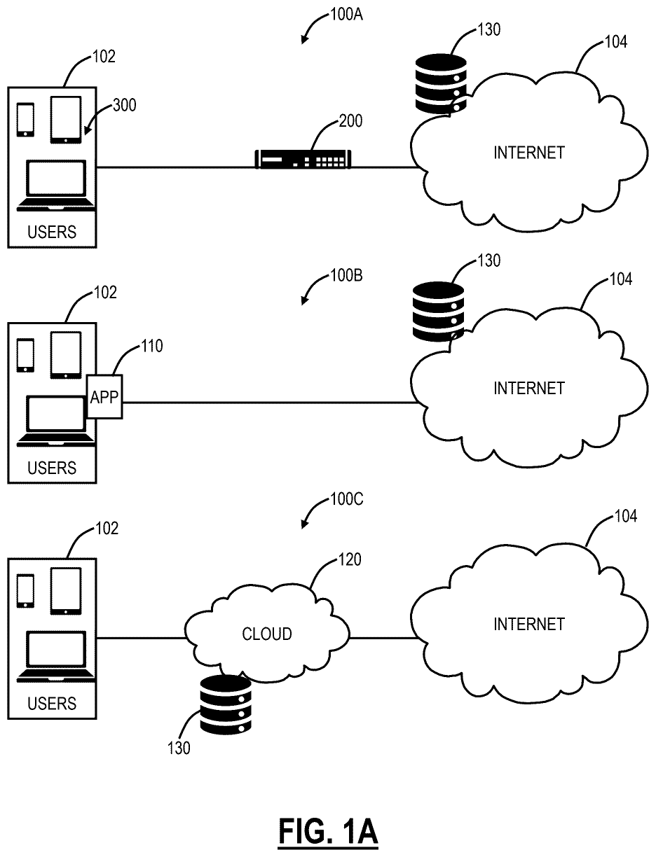

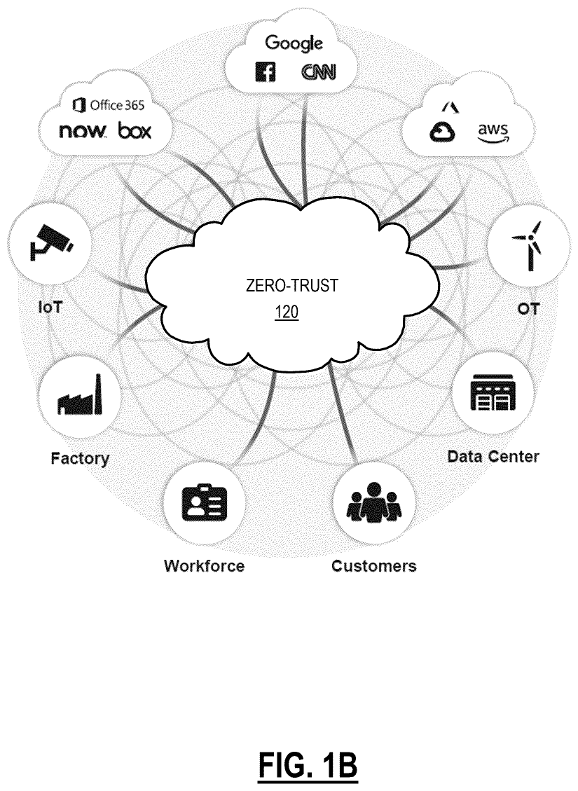

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

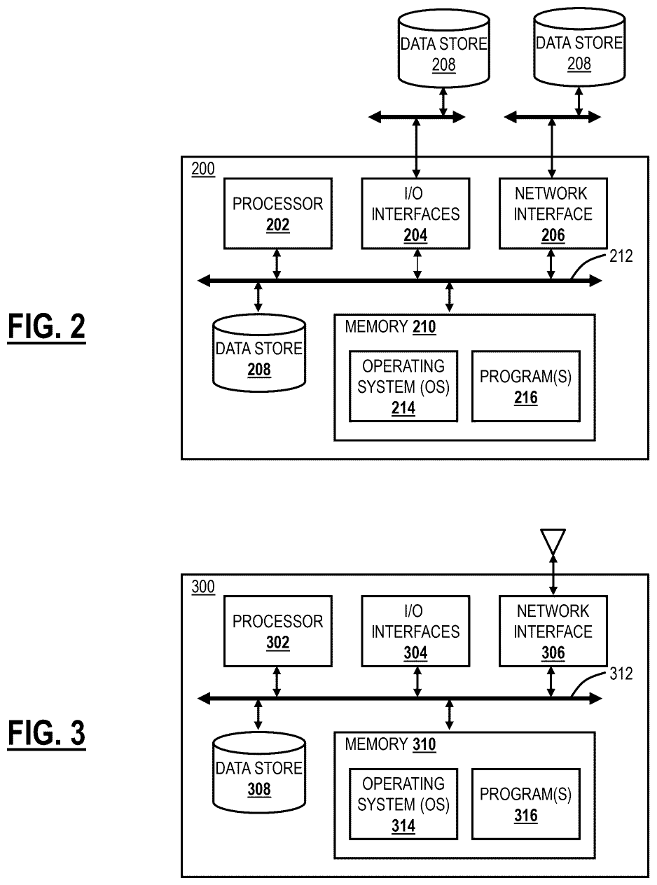

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Pat. No. 8,429,111, issued Apr. 23, 2013, and entitled “Encoding and compression of statistical data,” the contents of which are incorporated herein by reference, describes compression techniques for storing such logs,
Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing D Evice Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

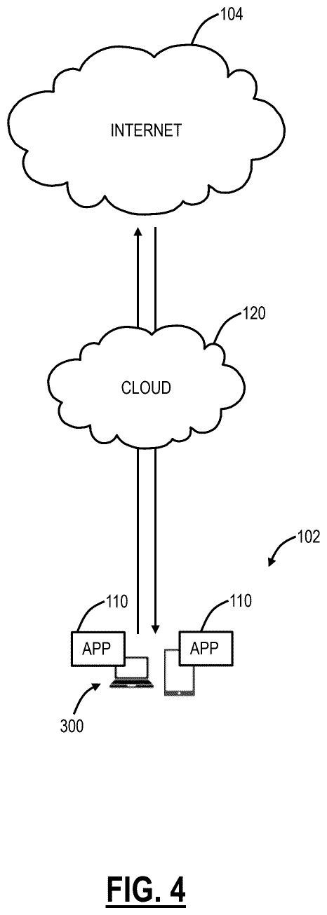

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Cloud Observability Framework

The present disclosure relates to systems and methods for monitoring, analyzing, and enhancing the health and performance of network systems, applications, and infrastructure components. In various embodiments, the primary objective is to provide monitoring and troubleshooting capabilities for services running in the cloud 120. The framework is designed to cater towards all functional teams across customers/tenants of the cloud 120. The framework enables writing of complex monitoring and troubleshooting flows that can target specific services or groups of services in the cloud 120. For example, it can enable support engineers to run a packet capture for a certain customer across a datacenter or on a specific node of the cloud 120. It will enable engineers to extract valuable metrics on the functionality of performance of their features running in production environments.

The observability framework is a comprehensive methodology engineered to deliver profound visibility into the performance, security, and operational facets of the cloud's 120 various security platforms. This framework employs a variety of tools and techniques to meticulously monitor, analyze, and enhance the health and performance of network systems, applications, and infrastructure components. Central to the framework is monitoring and metrics, which involves keeping a close watch on the health of the cloud 120 network. This includes parameters like latency, throughput, and overall availability to ensure robust network performance. Equally important is the tracking of service performance for services such as Zscaler Internet Access (ZIA) and Zscaler Private Access (ZPA), ensuring these services are operating within their expected parameters. Additionally, user experience metrics are crucial, as they measure the reliability and speed of user access to applications, a key indicator of service quality.

Logging is another critical component, capturing detailed traffic logs that include metadata such as source and destination IPs, URLs, and user IDs. This detailed log data is invaluable for security logs, which record security events and incidents detected by the security services of the cloud 120. These logs help in identifying malware, policy violations, and other threat indicators, providing a comprehensive view of the security landscape.

The framework also emphasizes tracing capabilities, such as request tracing, which follows individual user requests through the cloud 120 to pinpoint latency issues or bottlenecks. Transaction analysis further enhances this by examining the path of transactions across the cloud 120 to detect anomalies and performance degradation, offering insights that are critical for maintaining optimal performance.

Alerting and notifications are integral to the framework, with threshold-based alerts set up for key metrics like latency and error rates. Advanced anomaly detection methods, often leveraging machine learning, are used to identify unusual patterns in traffic and performance metrics, enabling proactive issue resolution.

To make this wealth of data actionable, the framework includes dashboards and visualization tools. Real-time dashboards provide instant insights into key metrics and logs, while historical analysis capabilities allow for the identification of long-term trends and patterns. These visual tools are essential for both immediate operational decisions and strategic planning.

The framework also supports analytics and reporting, offering the ability to generate custom reports that provide detailed insights into network and security performance. This includes compliance reporting, ensuring that observability data meets regulatory requirements and supports organizational compliance efforts.

Integration and automation capabilities are designed to enhance the utility of the observability data. API integration allows observability data associated with the cloud 120 to be merged with other IT and security management tools, creating a unified view of the IT environment. Automation further amplifies this by enabling automated responses to specific conditions, such as scaling resources or triggering security workflows, thereby reducing the need for manual intervention. For root cause analysis, the framework supports in-depth incident investigation, offering comprehensive visibility into all.

Currently, the cloud 120, more particularly the Zscaler cloud, has approximately 300,000 provisioned service instances. The primary objective of the present observability framework is to provide comprehensive visibility into each of these instances, regardless of their functionality or deployment model. It will be appreciated that the Zscaler cloud, also referred to as the cloud 120, offered by Zscaler, Inc. (the assignee and applicant of the present application), shall be contemplated as a non-limiting example. In various embodiments, the cloud 120 can include a plurality of clouds for providing distinct security services such as the security services described herein.

Via traditional methods, such an observability framework would face several constraints. Services are managed by different functional groups, each utilizing distinct development frameworks, and the deployment model of each service varies. Some services are directly reachable via public addresses, while others may reside behind Network Address Translation (NAT), hindering direct access. Additionally, certain services are always operational, while others are ephemeral, initiated to perform specific tasks and then terminated. Services such as the clouds 120 various nodes are highly critical, and any instrumentation or monitoring should not impair their primary functionality. Each service has its own development and upgrade cycles, and within a single service, different instances may run different versions, with certain functionalities available only in specific versions. Framework developers cannot anticipate or write customized toolsets or code for every possible monitoring or troubleshooting requirement for each type of service. Therefore, the present observability framework is adapted to avoid any hard coupling, both functionally and development-wise, to any specific service, and minimize the need for custom code on each individual system to interact with the observability framework.

To address these constraints, the observability framework is adapted to satisfy several goals. The development cycle of the framework is independent of the services it monitors, and it is able to connect to and interact with services running in any deployment model, including those deployed on customer premises. The observability framework is capable of monitoring even temporary services that may have periodic or rapid start-to-termination cycles. It can limit monitoring and troubleshooting requests based on constraints defined by the services themselves. For instance, critical services such as nodes will have higher constraints on monitoring and troubleshooting, which the observability framework is adapted to respect and enforce. The observability framework's communication channels are generic and free from dependencies on specific development languages, operating systems, or hardware. It can interact with different versions of the same service and execute monitoring and troubleshooting tasks on all available versions. The observability framework does not embed or hardcode any specific tasks or steps for any particular service. Instead, it provides lightweight, embeddable libraries in different programming languages, allowing individual development teams to integrate them into their applications seamlessly. Additionally, the observability framework is adapted to connect to external support services such as Kafka and Prometheus to store reports or stream metrics.

By fulfilling these architectural goals and constraints, the present observability framework can ensure comprehensive, reliable, and flexible monitoring and troubleshooting capabilities across all service instances, irrespective of their deployment models or operational lifespans.

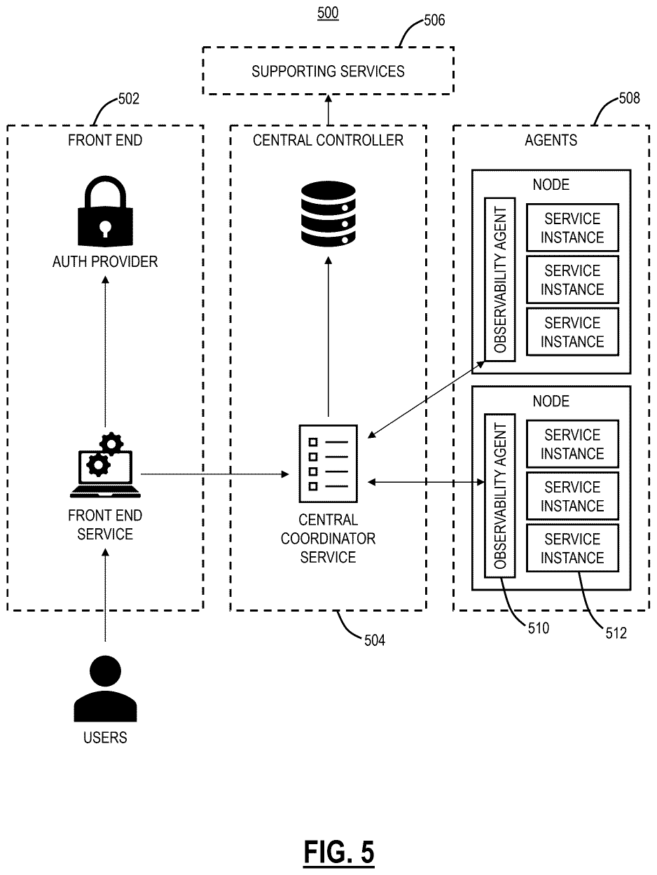

FIG. 5 is a flow diagram of the present observability framework. The diagram outlines the various systems associated with the observability framework 500 at a high level. The observability framework 500 can be grouped into four functional groups. The diagram in FIG. 5 outlines each functional group and the interaction between them. Each functional group is developed independently and all interaction across them is via APIs. Each individual functional group can choose to have their own proprietary communication channel or deep coupling among systems within the functional group, but any external interactions is API driven.

A first functional group includes a front end 502. The front end 502 serves as the initial entry point for users interacting with the observability framework 500. This functional group is responsible for authenticating users and providing Role-Based Access Control (RBAC) to ensure that users have appropriate access based on their roles. The front end 502 will present various troubleshooting steps through an intuitive and easy-to-use UI flow, making it simpler for users to navigate the framework's capabilities. When users initiate operational requests, such as collecting metrics, running diagnostics, or executing troubleshooting commands, these requests will be routed to the central controller 504. The front end 502 relies on APIs to communicate with the central controller 504, ensuring seamless interaction between the user interface and the framework's backend processes.

The front end 502 is capable of not only making requests but also tracking their progress in real-time. It is adapted to visually represents the status and completion of these requests to the user, providing clear and immediate feedback. This includes displaying progress bars, status updates, and notifications to keep users informed about the ongoing operations.

For user identification and authentication, the central controller 504 will connect to the cloud's 120 authentication provider, such as Okta. By integrating with a trusted authentication provider, the framework ensures secure and reliable user verification, maintaining the integrity of the system and protecting sensitive data.

The front end's 502 capabilities extend beyond simple request management. It also provides users with dashboards and visualization tools to monitor metrics and analyze data. These tools offer insights into the performance, health, and security of the network and applications, enabling users to make informed decisions.

In summary, the front end 502 of the observability framework 500 plays a crucial role in user experience and system functionality. It authenticates users, enforces RBAC, facilitates operational requests through the central controller 504, tracks and displays request progress, and integrates with external authentication providers for secure access. By doing so, it ensures that users can effectively interact with the framework to monitor, troubleshoot, and optimize their network and application performance.

The central controller 504 acts as the central brain of the observability framework 500, with the primary objective of receiving requests from the front end 502 and ensuring these requests are carried out to completion. While this objective may seem straightforward, the complexity of the requests can vary significantly, making the central controller's 504 role crucial in managing these complexities and ensuring seamless operation. The central controller 504 has two core functions including request management and agent management.

Regarding request management, the central controller 504 manages the entire lifecycle of each request. This begins with accepting and validating the requests received from the front end 502. Once validated, the central controller 504 executes the requests efficiently and reliably, ensuring that all tasks are completed accurately and within the specified time frame. Throughout the request lifecycle, it continuously updates the progress, providing real-time feedback to the front end 502 and, consequently, to the users. Additionally, the central controller 504 supports periodic queries that can run autonomously without human supervision, ensuring consistent monitoring and data collection.

Each request may involve post-processing steps that leverage one or more supporting services 506. The central controller 504 is responsible for facilitating these post-processing activities, ensuring seamless integration and execution. Furthermore, it needs to implement rate limiting based on the access control and priority of the user to maintain system integrity and protect critical cloud 120 services from being overwhelmed by excessive requests.

Regarding agent management, the central controller 504 also plays a pivotal role in managing agents, which are essential for executing monitoring, troubleshooting, and data collection tasks. It accepts connections from agents and registers them as part of the initial handshake and registration process. During this process, the central controller 504 receives and logs all capabilities of the agents, including their versions and functionalities.

Once registered, the central controller 504 sends various tasks to the agents, which could be monitoring, troubleshooting, or data collection tasks. The framework supports multiple methods for task assignment, including polling and push notifications, ensuring flexibility and responsiveness in task management. Additionally, the central controller 504 maintains a central registry of all connected agents and their capabilities. This registry is crucial for tracking the status and functionality of each agent, ensuring optimal allocation of tasks and effective management of resources.

Given the complex nature of troubleshooting steps, the observability framework 500 requires a flexible and dynamic approach to execute these tasks. Troubleshooting can involve multiple steps in a single flow. For instance, to perform a packet capture, the system may first need to identify the cloud node for a given user and then initiate the packet capture process. Each step within this flow can be a complex combination of multiple commands, and these steps may need to be executed on various types of cloud service instances. Furthermore, the result of each step may be necessary for the subsequent steps, creating a dependency chain that must be carefully managed.

Each troubleshooting step can lead to a complex set of executions, effectively constituting a series of individual commands executed in a specific sequence. Given the diverse range of services and the unique commands associated with each, the number of potential troubleshooting flows can be vast. It is impractical for the central controller 504 to model each troubleshooting flow as a hard-coded sequence of commands. To address this, the central controller 504 provides a JavaScript interpreter that can run scripts containing these commands.

The JavaScript interpreter allows for the representation of complex command flows within a script that the central controller 504 can evaluate and execute. This approach offers several advantages including the following.
Dynamic Execution: The interpreter can dynamically execute scripts, allowing for real-time adjustments and execution of commands based on the results of previous steps.
Flexibility: Scripts can be written to handle a wide range of scenarios without requiring changes to the central controller's 504 core codebase. This allows for flexibility in troubleshooting various types of issues across different services.
Reusability: Common troubleshooting flows can be encapsulated in scripts, which can then be reused across different instances and scenarios, reducing redundancy and improving efficiency.
Scalability: By using scripts, the framework can scale to manage the increasing complexity and variety of troubleshooting tasks without the need for extensive hard-coded logic.
Modularity: Scripts can be modular, breaking down complex troubleshooting flows into manageable parts that can be independently developed, tested, and maintained.

In practice, when a complex troubleshooting task is initiated, the central controller 504 will load the appropriate script into the JavaScript interpreter. The script will then be executed step-by-step, with each command being evaluated and run as needed. The interpreter can handle conditions, loops, and dependencies, ensuring that each step's results are appropriately passed to subsequent steps. By leveraging a JavaScript interpreter, the observability framework 500 can effectively manage and execute complex troubleshooting flows, providing a robust and scalable solution to meet the varied needs of the cloud 120 environment. This approach ensures that the framework remains flexible, adaptable, and capable of handling the intricacies of modern network and application troubleshooting.

The agents 508 are the workhorses of the observability framework 500, acting as the key components that expose metrics, accept commands, and execute them. Each cloud 120 service will operate with a specific type of agent tailored to its unique requirements. These agents 508 provide monitoring and troubleshooting capabilities through APIs, making it possible to interact with the service in a standardized manner. For example, an agent running on a load balancer might expose an API that allows for searching entries within its session table.

In some embodiments, a standalone agent can be deployed on systems across the cloud 120. This agent will be capable of interacting with any underlying service running on the system, significantly reducing the development effort required by service owners to interface with the central controller 504. Service owners can implement a thin layer of APIs and expose these to the standalone agent, thereby streamlining the integration process. The standalone agent will run on various systems, including critical components such as cloud nodes. The agent's design ensures that it can interact seamlessly with the central controller 504 while offering robust monitoring and troubleshooting functionalities. This approach minimizes the need for extensive custom development on each service, allowing for quicker and more efficient deployment of observability capabilities.

In this setup, the agent serves as an intermediary layer, interfacing with the underlying service and exposing necessary APIs for monitoring and troubleshooting. By centralizing these capabilities within the agent, we ensure a consistent and reliable method for collecting metrics and executing commands across the cloud 120.

The development of these standalone agents marks a significant step in enhancing the observability framework. It ensures that all services, regardless of their specific functionalities or deployment models, can be monitored and managed effectively. This not only improves the overall reliability and performance of the cloud 120 but also provides service owners with the tools they need to maintain and troubleshoot their services with minimal overhead.

In various embodiments, the agents 508 can include service specific agents, or observability agents 510. That is, each service of the cloud 120 can run a form of an agent specifically tailored to its unique requirements. Again, for example, an observability agent 510 on a load balancer service of the cloud 120 can be adapted to expose an API to search entries within its session table. Such service-specific functionality ensures that each observability agent 510 can provide detailed, relevant data and control options for the particular service to which it is associated.

Again, these observability agents 510 are tailored to the specific needs and functionalities of each service in the cloud 120, providing a standardized yet flexible method for interacting with the observability framework. The core functions of service-specific agents/observability agents 510 include metrics exposure, command execution, and monitoring and troubleshooting. Observability agents 510 collect various performance metrics such as CPU usage, memory consumption, and network traffic, exposing these metrics through APIs for retrieval and analysis by the central controller 504 and other components of the observability framework 500. They also accept commands from the central controller 504, executing tasks like running diagnostics, capturing packets, and performing specific troubleshooting steps within the service environment with respect to the specific needs and functionalities of the service or service instance 512. Additionally, observability agents 510 continuously monitor the health and performance of the services, offering advanced troubleshooting capabilities to identify bottlenecks, trace transactions, and pinpoint failures.

In terms of implementation and deployment, each service runs a specific type of observability agent 510 tailored to its unique requirements. For example, an agent on a firewall might focus on logging and analyzing traffic patterns. Despite this customization, all observability agents 510 follow a unified protocol for interacting with the central controller 504, ensuring consistency across the observability framework 500. Upon deployment, observability agents 510 connect to the central controller 504, registering themselves and their capabilities. This initial handshake ensures that the central controller 504 is aware of all available agents and their functionalities. Again, the central controller maintains a central registry of all connected observability agents 510 and their capabilities, including version information, which is crucial for task allocation and resource management.

In conclusion, the agents 508 are integral to the observability framework, providing the essential capabilities needed to monitor and manage the diverse range of services within the cloud 120. By developing standalone agents that can be easily integrated with existing services, the present systems can achieve comprehensive visibility and control, ensuring the optimal performance and reliability of the entire system.

Further, the supporting services 506 are integral to extending the capabilities of the observability framework. Each request can specify a flow for these supporting services 506 as part of post-processing. For instance, a request might involve collecting a specific set of metrics from a particular type of service instance using the framework. Once the data collection is complete, the request can instruct the coordinator to push the collected metrics to supporting services such as Prometheus or InfluxDB. Each supporting service has a corresponding plugin on the coordinator. These plugins enable the coordinator to interface with various types of supporting services seamlessly. For example, there is a plugin for Kafka that implements the Kafka client. This plugin can be used to stream data to Kafka, providing a flexible and robust mechanism for integrating with external data processing and storage systems.

By leveraging these plugins, the framework can interact with a wide array of supporting services, thereby enhancing its functionality and adaptability. This modular approach allows for the easy incorporation of new supporting services as needed, without requiring significant changes to the core framework. The plugins facilitate smooth data transfer and integration, ensuring that the observability framework can meet diverse operational requirements.

Key design components of the present observability framework include agents 508 that connect to the central controller 504. This connection supports bidirectional communication. If alternatively, the central controller 504 connected to the agents 508, the system would not be scalable, and would not support monitoring services behind NATted deployments. Additionally, the API discovery methods allow the central controller 504 to discover all functionalities supported by observability agents 510.

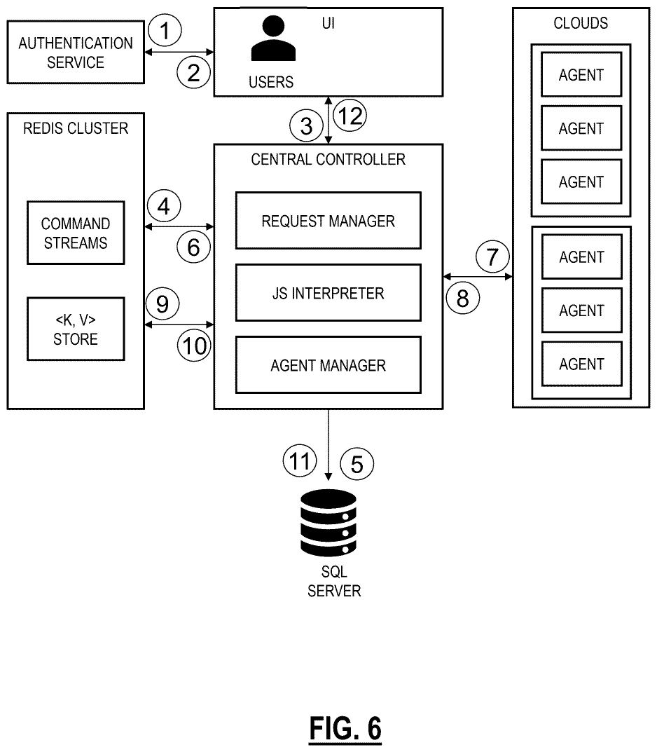

FIG. 6 is a flow diagram of an example request flow through the observability framework. Users begin by submitting a login request to the authentication service (step 1), which can be initiated through a helpdesk ticket for access to the observability framework 500 portal. The authentication service then validates the provided credentials with Okta, or any other Identity and Access Management (IAM) provider. Upon successful validation, it generates a JWT token (step 2) containing the user's roles and permissions and sends this token back to the User Interface (UI). Next, the user selects the job type they wish to execute and submits the job to the central controller API (step 3). This submission includes the required parameters based on the selected job type and the JWT token for authentication. The central controller 504, specifically the Request Manager (RM), performs several critical steps at this point. It validates the request to ensure all mandatory parameters for the given job type are present, verifies the authenticity of the user and the JWT token, and checks the roles and permissions embedded in the token. Upon successful validation, the central controller 504 generates a time-sorted unique ID for the submitted job, known as exec_id, and submits a request to the Redis Cluster using Redis Streams for each command specified in the job type request from the corresponding JavaScript interpreter file. Redis Streams then creates a new stream for each command with a unique ID, referred to as cmd_id (step 4). The central controller 504 stores the job details in a SQL database and updates the job status to “IN_QUEUE” for the generated exec_id (step 5). The Agent Manager (AM) within the central controller 504 then receives and reads the job from the command streams (step 6). The JavaScript interpreter collects the necessary information from the AM and submits the job to the requested agents (step 7). These agents process the request and send their responses back to the central controller 504 (step 8). Upon receiving the responses, the central controller 504. Via the AM, updates the command streams with the responses and updates the status for each command in the Redis key-value store (step 9). The central controller 504, via the RM, then verifies if all command responses have been received and combines them into a final result (step 10). This final status is updated in the PostgreSQL database (step 11). Finally, the central controller 504, via the RM, sends the combined response back to the user upon request, completing the entire process (step 12).

### § 5.1 Observability Framework Process

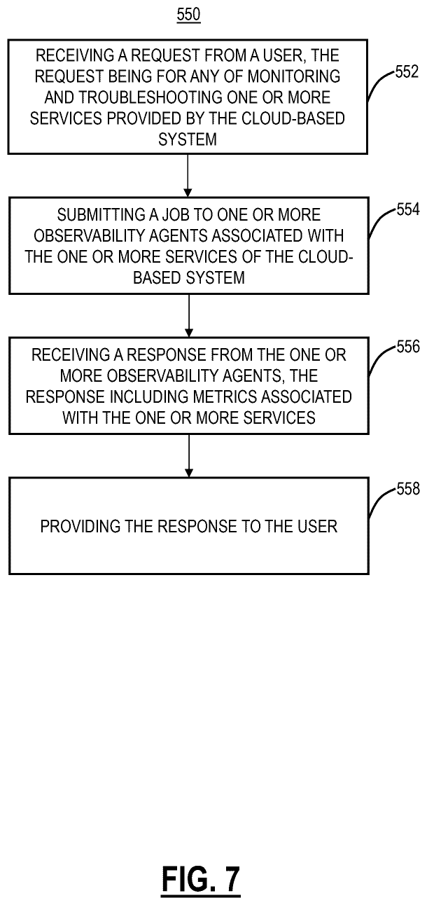

FIG. 7 is a flowchart of a process 550 for a cloud observability framework. The process 550 can be contemplated as a method having steps, a processing device configured to implement the steps, a cloud-based system configured to implement the steps, and as a non-transitory computer-readable medium storing instructions for programming one or more processors to execute the steps. The process 550 includes receiving a request from a user, the request being for any of monitoring and troubleshooting one or more services provided by the cloud-based system (step 552); submitting a job to one or more observability agents associated with the one or more services of the cloud-based system (step 554); receiving a response from the one or more observability agents, the response including metrics associated with the one or more services (step 556); and providing the response to the user (step 558).

The process 550 can further include providing a real-time status of the request to the user between receiving the request and providing the response. Providing the response to the user can be via a User Interface (UI), wherein the response includes graphical representations of the metrics associated with the one or more services. The one or more observability agents can be service-specific and tailored to specific requirements of their associated service. Each of the one or more service-specific observability agents can follow a unified protocol for interacting with the cloud observability framework. The steps can include performing a registration procedure for each of the one or more observability agents, thereby ensuring that the cloud observability framework is aware of all available observability agents and their functionalities. The cloud observability framework can be adapted to submit jobs to specific observability agents based on the one or more services associated with the request.

### § 6.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for providing monitoring and troubleshooting for services of a cloud-based system via a cloud observability framework, the method comprising steps of:
receiving a request from a user, the request being for any of monitoring and troubleshooting one or more services provided by the cloud-based system;
submitting a job to one or more observability agents associated with the one or more services of the cloud-based system;
receiving a response from the one or more observability agents, the response including metrics associated with the one or more services; and
providing the response to the user.

2. The method of claim 1, wherein the steps further comprise:
providing a real-time status of the request to the user between receiving the request and providing the response.

3. The method of claim 1, wherein providing the response to the user is via a User Interface (UI), and wherein the response includes graphical representations of the metrics associated with the one or more services.

4. The method of claim 1, wherein the one or more observability agents are service-specific and tailored to specific requirements of their associated service.

5. The method of claim 4, wherein each of the one or more service-specific observability agents follow a unified protocol for interacting with the cloud observability framework.

6. The method of claim 1, wherein the steps include performing a registration procedure for each of the one or more observability agents, thereby ensuring that the cloud observability framework is aware of all available observability agents and their functionalities.

7. The method of claim 1, wherein the cloud observability framework is adapted to submit jobs to specific observability agents based on the one or more services associated with the request.

8. A non-transitory computer-readable medium comprising instructions for providing monitoring and troubleshooting for services of a cloud-based system via a cloud observability framework that, when executed, cause one or more processors to perform steps of:
receiving a request from a user, the request being for any of monitoring and troubleshooting one or more services provided by the cloud-based system;
submitting a job to one or more observability agents associated with the one or more services of the cloud-based system;
receiving a response from the one or more observability agents, the response including metrics associated with the one or more services; and
providing the response to the user.

9. The non-transitory computer-readable medium of claim 8, wherein the steps further comprise:
providing a real-time status of the request to the user between receiving the request and providing the response.

10. The non-transitory computer-readable medium of claim 8, wherein providing the response to the user is via a User Interface (UI), and wherein the response includes graphical representations of the metrics associated with the one or more services.

11. The non-transitory computer-readable medium of claim 8, wherein the one or more observability agents are service-specific and tailored to specific requirements of their associated service.

12. The non-transitory computer-readable medium of claim 11, wherein each of the one or more service-specific observability agents follow a unified protocol for interacting with the cloud observability framework.

13. The non-transitory computer-readable medium of claim 8, wherein the steps include performing a registration procedure for each of the one or more observability agents, thereby ensuring that the cloud observability framework is aware of all available observability agents and their functionalities.

14. The non-transitory computer-readable medium of claim 8, wherein the cloud observability framework is adapted to submit jobs to specific observability agents based on the one or more services associated with the request.

15. A cloud-based system comprising:
one or more processors; and
memory storing computer-executable instructions for providing monitoring and troubleshooting for services of the cloud-based system via a cloud observability framework that, when executed, cause the one or more processors to:
receive a request from a user, the request being for any of monitoring and troubleshooting one or more services provided by the cloud-based system;
submit a job to one or more observability agents associated with the one or more services of the cloud-based system;
receive a response from the one or more observability agents, the response including metrics associated with the one or more services; and
provide the response to the user.

16. The cloud-based system of claim 15, wherein the instructions, when executed, further cause the one or more processors to:
provide a real-time status of the request to the user between receiving the request and providing the response.

17. The cloud-based system of claim 15, wherein providing the response to the user is via a User Interface (UI), and wherein the response includes graphical representations of the metrics associated with the one or more services.

18. The cloud-based system of claim 15, wherein the one or more observability agents are service-specific and tailored to specific requirements of their associated service.

19. The cloud-based system of claim 18, wherein each of the one or more service-specific observability agents follow a unified protocol for interacting with the cloud observability framework.

20. The cloud-based system of claim 15, wherein the instructions, when executed, further cause the one or more processors to perform a registration procedure for each of the one or more observability agents, thereby ensuring that the cloud observability framework is aware of all available observability agents and their functionalities.
